(19) United States
(12) Patent Application Publication
(10) Pub. No.: US 2026/0086547 A1
(43) Pub. Date: Mar. 26, 2026

(54) OPERATING STATE MONITORING SYSTEM, INFORMATION PROCESSING APPARATUS, AND INFORMATION PROCESSING METHOD

(71) Applicant: Toshiba Tec Kabushiki Kaisha, Tokyo (JP)

(72) Inventor: Satoshi KATSUMATA, Numazu Shizuoka (JP)

(21) Appl. No.: 19/290,737

(22) Filed: Aug. 5, 2025

(30) Foreign Application Priority Data
Sep. 20, 2024 (JP) 2024-163773

(51) Int. Cl. G05B 23/02

(52) U.S. Cl. CPC G05B 23/0221; G05B 23/0272

(57) ABSTRACT

According to an embodiment, a machine operating state monitoring system measures a current flowing through a signal light attached to a machine to be monitored. The machine operating state monitoring system determines an operating state of the signal light on the basis of a measurement result of the current. The machine operating state monitoring system stores in advance a relationship between the operating state of the signal light and the operating state of the machine to be monitored. Furthermore, the machine operating state monitoring system determines an operating state of a machine to be monitored corresponding to the determined operating state of the signal light on the basis of the stored relationship.

### CROSS-REFERENCE TO RELATED APPLICATIONS

This application is based upon and claims the benefit of priority from the prior Japanese Patent Application No. 2024-163773, filed on Sep. 20, 2024, the entire contents of which are incorporated herein by reference.

### FIELD

Embodiments described herein generally relate to an operating state monitoring system, an information processing apparatus, and an information processing method.

### BACKGROUND

Conventionally, in order to grasp the operating state of a machine, a current flowing to the power supply of the machine has been measured, and the operation of the machine has been determined from the presence or absence of the current associated with the operation. However, this fails to grasp a detailed operating state of the machine solely on the basis of whether or not the machine is operating. In addition, the power supply of the machine has a large current and voltage, resulting in the problems that the measurement equipment is large and power consumption is high.

In addition, the operation of a signal light attached to the machine, which indicates the state of the machine, can also be determined in the same manner on the basis of whether the signal light is turned on or turned off. However, further details of the operating state (blinking, flashing, etc.) cannot be determined and must be determined by a human visually checking the state of the signal light.

### BRIEF DESCRIPTION OF THE DRAWINGS

FIG. 1 is a block diagram showing an overall configuration of a machine operating state monitoring system according to an embodiment.

FIG. 2 is a block diagram showing a main part circuit configuration and a program outline of a monitoring server as an information processing apparatus according to the embodiment.

FIG. 3 is a diagram showing an example of stored contents of a correspondence storage section and a notification destination storage section, respectively, according to the embodiment.

FIG. 4 is a flowchart showing a first part of a sequence of flows showing the procedure of main information processing performed by a processor of the monitoring server according to the embodiment.

FIG. 5 is a flowchart showing a second part of a sequence of flows showing the procedure of the main information processing performed by the processor of the monitoring server according to the embodiment.

FIG. 6 is a diagram showing examples of a measurement pattern according to the embodiment.

FIG. 7 is a schematic diagram showing examples of the measurement pattern according to the embodiment.

FIG. 8 is a diagram showing examples of a signal light pattern according to the embodiment.

FIG. 9 is a schematic diagram showing examples of the signal light pattern according to the embodiment.

FIG. 10 is a diagram showing examples of saved contents of an operating state saving section according to the embodiment.

FIG. 11 is a block diagram showing a main part circuit configuration and a program outline of a monitoring server as an information processing apparatus according to a second embodiment.

### DETAILED DESCRIPTION

According to an embodiment, a machine operating state monitoring system includes a machine to be monitored, a signal light, a current sensor, and a monitoring server. The signal light is attached to the machine to be monitored. The signal light is configured to present an operating state of the machine to be monitored by changing an operating state of the signal light in accordance with the operating state of the machine to be monitored. The current sensor is connected to a network. The current sensor is configured to detect a current value of a current flowing through the signal light. The monitoring server is configured to determine the operating state of the machine to be monitored. The monitoring server includes a communication interface, a storage device, and a processor. The communication interface is connected to the network. The storage device is configured to store in advance a relationship between the operating state of the signal light and the operating state of the machine to be monitored. The processor is configured to receive a detection result of the current value of the current flowing through the signal light from the current sensor via the communication interface. The processor is configured to determine the operating state of the signal light on the basis of the received detection result of the current value. The processor is configured to determine the operating state of the machine to be monitored that corresponds to the determined operating state of the signal light on the basis of the relationship between the operating state of the signal light and the operating state of the machine to be monitored, the relationship being stored in the storage device.

Hereinafter, embodiments will be described with reference to the drawings. In the drawings, the same reference symbols indicate the same or similar parts.

### First Embodiment

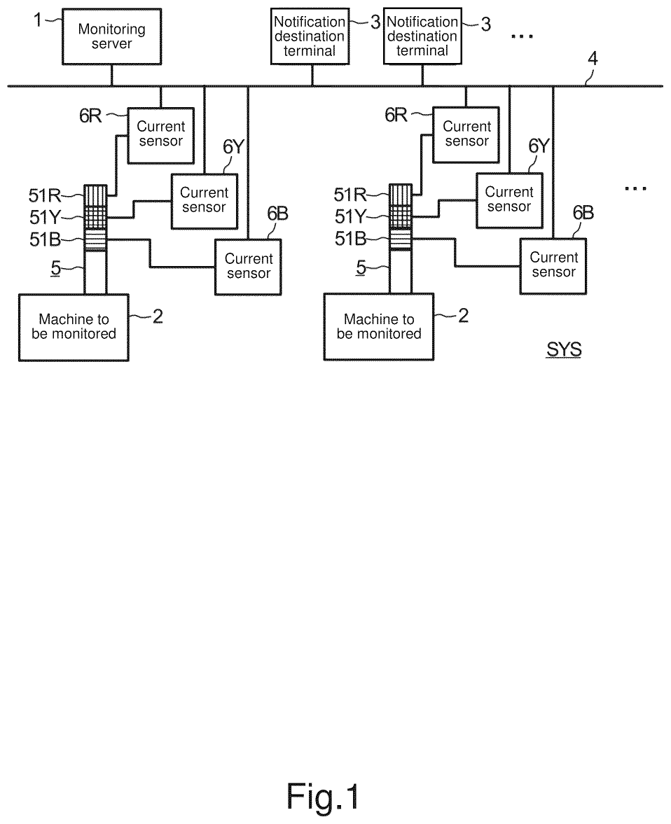

FIG. 1 is a block diagram showing an overall configuration of a machine operating state monitoring system SYS according to a first embodiment. The machine operating state monitoring system SYS includes a monitoring server 1, one or more machines to be monitored 2, and one or more notification destination terminals 3. The monitoring server 1 is an example of an information processing apparatus according to a first embodiment. The machine to be monitored 2 is a machine for which the monitoring server 1 has to determine the operating state. The notification destination terminal 3 is a terminal operated by a monitoring person to whom the monitoring server 1 notifies a determination result according to the determination result. The monitoring server 1 and the notification destination terminal 3 are connected to each other via a communication network 4. The machine to be monitored 2 is not connected to the communication network 4, and thus the monitoring server 1 and the notification destination terminal 3 fail to directly obtain the operating state of the machine to be monitored 2. The communication network may be a user-restricted network, such as a wired or wireless local area network (LAN), provided in a specific area, for example, within a company or factory where the machine to be monitored 2 is installed, or it may be a network where users are not restricted, such as the Internet or various public networks.

An indication pole 5 is attached to the machine to be monitored 2. The indication pole 5 includes, for example, at the tip end thereof, three signal lights of a red signal light 51R, a yellow signal light 51Y, and a blue signal light 51B (hereinafter, collectively referred to simply as signal light 51 when the individual lights are not specifically distinguished). Of course, this is just one example, and the number of signal lights 51 is not limited thereto. The signal lights 51 are not limited to the form of the indication pole 5. The signal lights 51 may be configured as indicators arranged in a horizontal row, or the individual signal lights 51 may be attached to different locations of the machine to be monitored 2. In other words, the form in which the signal lights 51 are attached to the machine to be monitored 2 is not limited in any way. Each signal light 51 presents, using its operating state, the operating state of the machine to be monitored 2 to which the signal light 51 is attached. It can also be rephrased that the machine to be monitored 2 causes the signal light 51 to present the operating state of the machine to be monitored 2. The signal light 51 is an example of a signal light that is attached to a machine to be monitored 2 and presents the operating state of the machine to be monitored 2.

Further, the machine operating state monitoring system SYS includes a current sensor corresponding to each signal light 51. In other words, the machine operating state monitoring system SYS includes three current sensors of a current sensor 6R for the red signal light 51R, a current sensor 6Y for the yellow signal light 51Y, and a current sensor 6B for the blue signal light 51B (hereinafter, collectively referred to simply as current sensor 6 when the individuals are not specifically distinguished). The current sensor 6 is connected to the communication network 4, detects a current flowing through a corresponding signal light 51 in response to a measurement instruction from the monitoring server 1, and transmits the detected current value to the monitoring server 1. Note that the current sensor 6 does not have a built-in function to connect to the communication network 4, but may be connected to the communication network 4 via a separate, not-shown connection device or the like. In addition, the current sensor 6 may also detect a current flowing through a corresponding signal light 51 at all times, and its connection device or the like may transmit a detection result of the current sensor 6 to the monitoring server 1 in response to a measurement instruction from the monitoring server 1.

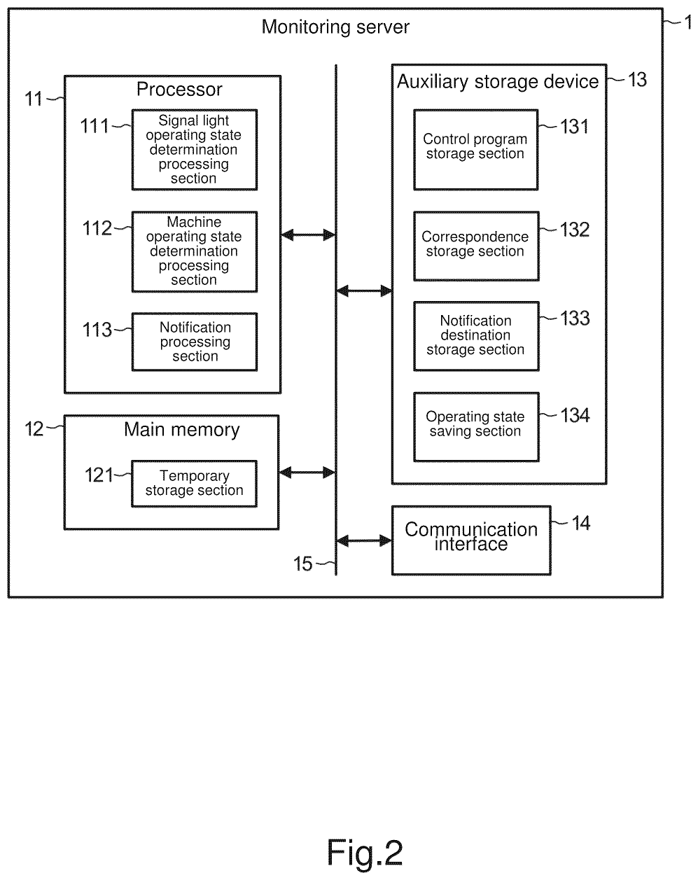

FIG. 2 is a block diagram showing a main part circuit configuration and a program outline of the monitoring server 1. The monitoring server 1 includes a processor 11, a main memory 12, an auxiliary storage device 13, a communication interface 14, and a system transmission path 15. The system transmission path 15 includes an address bus, a data bus, a control signal line, and the like. The monitoring server 1 connects the processor 11, the main memory 12, the auxiliary storage device 13, and the communication interface 14 to the system transmission path 15. The monitoring server 1 constitutes a computer by the processor 11, the main memory 12, the auxiliary storage device 13, and the system transmission path 15 that connects those components. Note that the monitoring server 1 includes a clock that measures the current time of day, though not specifically shown in the figure.

The processor 11 corresponds to the central part of the computer described above. The processor 11 controls each part to implement various functions as the monitoring server 1 according to the operating system and application programs. The processor 11 is, for example, but not limited to, a central processing unit (CPU). The processor 11 may be a multi-core/multi-threaded processor and can execute a plurality of processes in parallel. In addition, the processor 11 may be a micro processing unit (MPU). Additionally, the processor 11 may be implemented in various forms including an integrated circuit, such as an application specific integrated circuit (ASIC), a graphics processing unit (GPU), a field-programmable gate array (FPGA), a digital signal processor (DSP), a system on a chip (SoC), or a programmable logic device (PLD). In addition, the processor 11 may be a combination of some of those above.

The main memory 12 corresponds to a main storage part of the computer. The main memory 12 includes a non-volatile memory area and a volatile memory area. The main memory 12 stores the operating system and application programs in the non-volatile memory area. The main memory 12 may store data, which is necessary for the processor 11 to execute processing for controlling each part, in the non-volatile or volatile memory area. The main memory 12 uses the volatile memory area as a temporary storage section 121 in which data is rewritten by the processor 11 as appropriate. For example, the non-volatile memory area is a read only memory (ROM). The volatile memory area is a random access memory (RAM).

The auxiliary storage device 13 corresponds to an auxiliary storage part of the computer. For example, the auxiliary storage device 13 is an electric erasable programmable read-only memory (EEPROM) (registered trademark), a hard disc drive (HDD), a solid state drive (SSD), or the like. The auxiliary storage device 13 stores data used by the processor 11 to perform various types of processing, and data generated by the processing of the processor 11. The auxiliary storage device 13 may store the application programs described above.

The communication interface 14 transmits and receives data to and from the notification destination terminal 3 and the current sensor 6 connected via the communication network 4 in accordance with a communication protocol.

The monitoring server 1 includes a control program storage section 131, a correspondence storage section 132, a notification destination storage section 133, and an operating state saving section 134 in the auxiliary storage device 13.

The control program storage section 131 stores a control program that causes the processor 11 to implement each processing section to be described later according to this embodiment. The control program includes settings for measurement patterns and signal light patterns as will be described later.

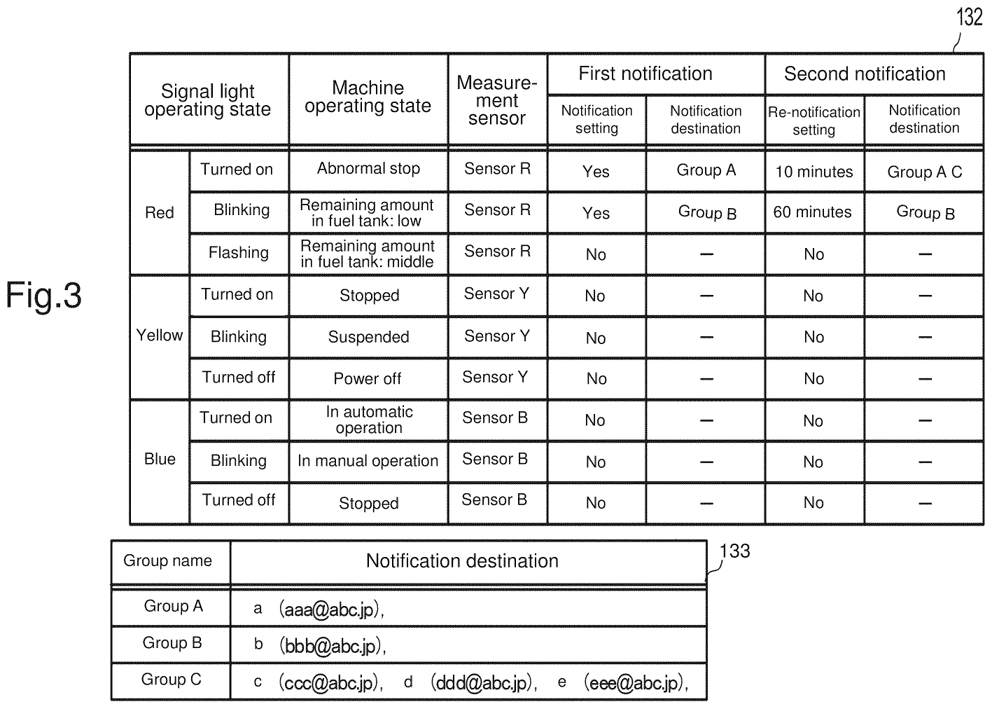

The correspondence storage section 132 stores a relationship between the operating state of the signal light 51 and the operating state of the machine to be monitored 2. The notification destination storage section 133 stores an actual notification destination (see notification destination terminal 3 of FIG. 1). FIG. 3 is a diagram showing an example of stored contents of the respective correspondence storage section 132 and notification destination storage section 133.

As shown in FIG. 3, for each of the three signal lights 51 of the red signal light 51R, the yellow signal light 51Y, and the blue signal light 51B, the correspondence storage section 132 stores a machine operating state that is the operating state of the a machine to be monitored 2, and a current sensor 6, which correspond to each signal light operating state that is the operating state of the signal light 51. In FIG. 3, “red” represents the red signal light 51R, “yellow” represents the yellow signal light 51Y, “blue” represents the blue signal light 51B, “sensor R” represents the current sensor 6R, “sensor Y” represents the current sensor 6Y and “sensor B” represents the current sensor 6B. Therefore, for example, the correspondence storage section 132 stores the correspondence for the “red” signal light 51, i.e., the red signal light 51R, in which: a signal light operating state of “turned on” corresponds to a machine operating state of “abnormal stop” and the current sensor 6R; a signal light operating state of “blinking” corresponds to a machine operating state of “remaining amount in fuel tank: low” and the current sensor 6R; and a signal light operating state of “flashing” corresponds to a machine operating state of “remaining amount in fuel tank: middle” and the current sensor 6R. In such a manner, the correspondence storage section 132 is an example of a storage section that stores in advance the relationship between the operating state of the signal light 51, the operating state of the machine to be monitored 2, and the current sensor 6 (measurement sensor in FIG. 3). The correspondence storage section 132 is an example of a storage device that stores in advance the relationship between the operating state of the signal light 51, which is attached to the machine to be monitored 2 and presents the operating state of the machine to be monitored 2, and the operating state of the machine to be monitored 2.

Further, as shown in FIG. 3, the correspondence storage section 132 stores the settings related to notification for each signal light operating state of each signal light 51. The settings related to notification include a setting related to first notification and a setting related to second notification. The setting related to first notification stores a notification setting that indicates whether to notify the operating state of the machine to be monitored 2, and a notification destination in the case where the notification setting is “Yes”, i.e., notification is to be performed. The notification destination is an example of a first notification destination. In addition, the setting related to second notification stores a re-notification setting indicating whether to perform re-notification and a re-notification setting time at which re-notification is performed, and a notification destination in the case of performing re-notification. This notification destination is an example of a second notification destination.

In addition, as shown in FIG. 3, the notification destination storage section 133 stores an actual notification destination address for each notification destination stored in the correspondence storage section 132.

The operating state saving section 134 stores the operating state of the machine to be monitored 2. The specific stored contents of the operating state saving section 134 will be described later.

Next, each part implemented by the processor 11 of the monitoring server 1 will be described. The processor 11 implements, for example, a signal light operating state determination processing section 111, a machine operating state determination processing section 112, and a notification processing section 113. Each part implemented by the processor 11 can also be referred to as each functional module. Each part implemented by the processor 11 can also be referred to as a control program executed by a controller including the processor 11 and the main memory 12. The control program is an example of a program for controlling an information processing apparatus that determines the operating state of the machine to be monitored 2.

The signal light operating state determination processing section 111 gives a measurement instruction to a current sensor 6 by the communication interface 14 via the communication network 4, the current sensor 6 corresponding to each signal light 51 attached to each machine to be monitored 2. The signal light operating state determination processing section 111 then receives via the communication interface 14 a detection result of a current flowing through the signal light 51 corresponding to each current sensor 6, the detection result being transmitted from each current sensor 6 via the communication network 4, and causes the temporary storage section 121 of the main memory 12 to store the detection result. The signal light operating state determination processing section 111 and the current sensor 6 are an example of a measurement section that measures the current flowing through the signal light 51 that is attached to the machine to be monitored 2 and presents the operating state of that machine to be monitored 2.

Further, the signal light operating state determination processing section 111 determines which signal light pattern set in advance as part of the control program stored in the control program storage section 131 is to be matched with the detection result of each current sensor 6 stored in the temporary storage section 121 of the main memory 12. The signal light operating state determination processing section 111 determines the operating state corresponding to the matched signal light pattern, as the operating state of the signal light 51 in which the current sensor 6 has detected a current. The signal light operating state determination processing section 111 causes the temporary storage section 121 of the main memory 12 to store the determined signal light operating state. The signal light operating state determination processing section 111 is an example of a first determination section that determines the operating state of the signal light 51 on the basis of a measurement result of the current by the measurement section.

The machine operating state determination processing section 112 determines, as a machine-to-be-monitored operating state, the operating state of the machine to be monitored 2 that corresponds to the signal light operating state stored in the temporary storage section 121 of the main memory 12 on the basis of the relationship between the operating state of the signal light 51 attached to the machine to be monitored 2 and the operating state of the machine to be monitored 2, the relationship being stored in advance in the correspondence storage section 132. The machine operating state determination processing section 112 is an example of a second determination section that determines the operating state of the machine to be monitored 2, which corresponds to the operating state of the signal light 51 determined by the first determination section, on the basis of the relationship stored in the correspondence storage section 132.

Further, the machine operating state determination processing section 112 causes the operating state saving section 134 to store the determined machine-to-be-monitored operating e together with the signal light operating state.

The notification processing section 113 determines whether or not the notification setting of “Yes” is stored in the correspondence storage section 132 for the machine-to-be-monitored operating state determined by the machine operating state determination processing section 112. If the notification setting is “Yes”, in response thereto, the notification processing section 113 reads an actual notification destination corresponding to the notification destination stored in the correspondence storage section 132 from the notification destination storage section 133. The notification processing section 113 then notifies the machine-to-be-monitored operating state to the notification destination terminal 3, which is an actual notification destination, by the communication interface 14 via the communication network 4. The notification processing section 113 is an example of a notification section that notifies the operating state of the machine to be monitored 2 to the notification destination if a notification destination corresponding to the operating state of the machine to be monitored 2, which has been determined by the second determination section, is stored in the correspondence storage section 132.

Note that the monitoring server 1 can be achieved by, for example, using a general-purpose computer apparatus for servers as hardware to write a control program as an application program in the auxiliary storage device 13 (which may be the main memory 12). The control program may be stored in the auxiliary storage device 13 or the main memory 12 when the monitoring server 1 is transferred, or it may be transferred separately from the general-purpose computer apparatus described above. In the latter case, the control program is transferred by being recorded on a removable recording medium such as a magnetic disk, a magneto-optical disk, an optical disc, or a semiconductor memory, or transferred over a network.

Next, the operation of the monitoring server 1 configured as described above will be described. Note that the contents of various types of processing to be described later are examples, and various types of processing that can achieve similar results can be used as appropriate.

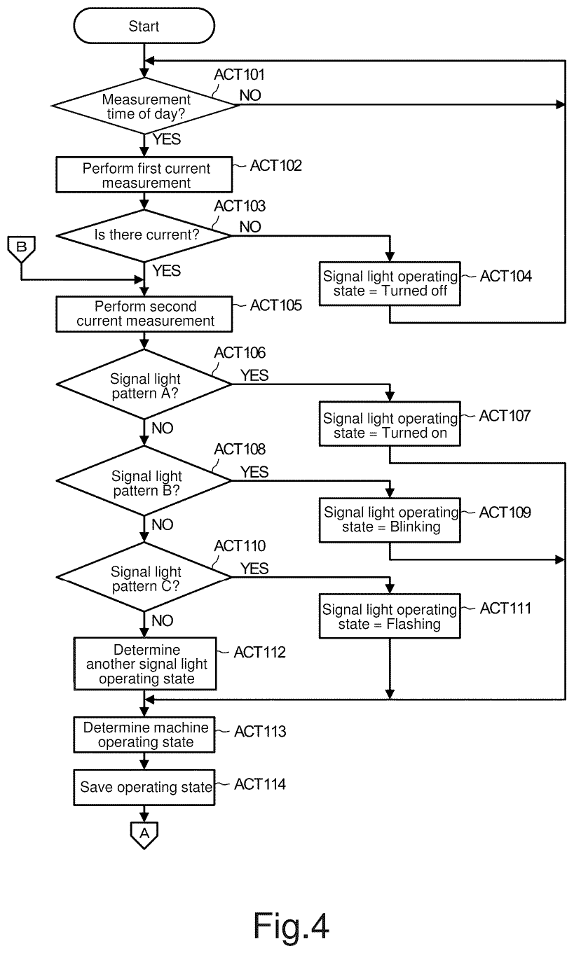

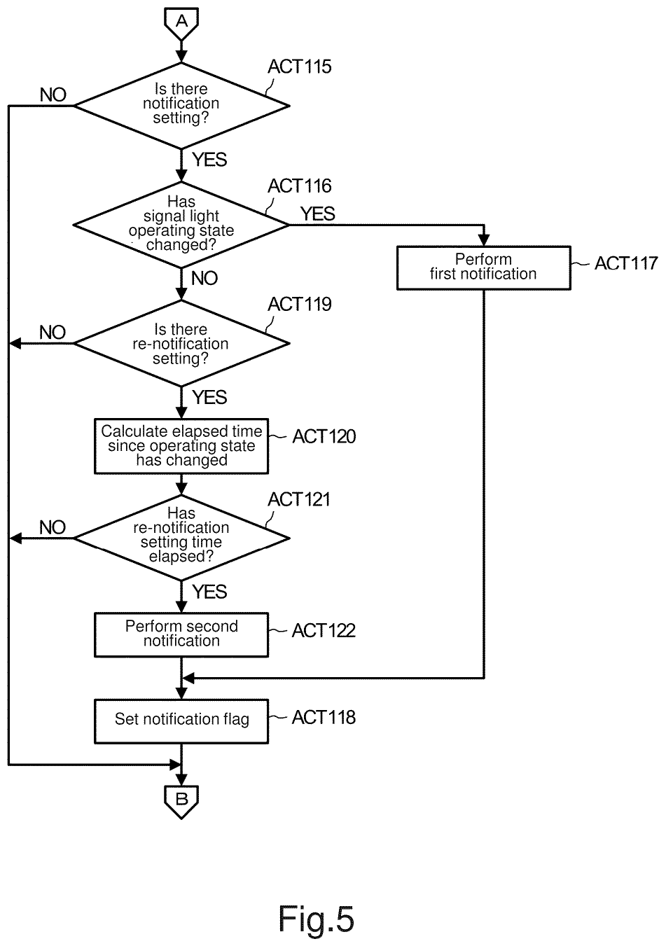

When the monitoring server 1 is in a normal operating state, the processor 11 executes, for example, information processing based on the control program stored in the control program storage section 131 of the auxiliary storage device 13. FIGS. 4 and 5 are diagrams of a sequence of flows showing the procedure of main information processing executed by the processor 11. Note that the processing shown in the flowcharts shows the procedure related to the individual current sensors 6. The processor 11 may perform this procedure for a single current sensor 6 one by one in chronological order with respect to a plurality of current sensors 6 provided in the machine operating state monitoring system SYS, or it may perform this procedure in parallel with respect to one or more current sensors 6. Note that the processing of the processor 11 shown in FIGS. 4 and 5 is assumed to proceed, after ACTn (n is a natural number), to ACT(n+1), unless otherwise described.

As ACT101, the signal light operating state determination processing section 111 implemented by the processor 11 determines whether or not a measurement time of day has come according to the measurement pattern registered in advance included in the control program stored in the control program storage section 131. If a measurement time of day has not yet come, the signal light operating state determination processing section 111 determines NO and executes ACT101 again. In addition, if a measurement time of day has come, the signal light operating state determination processing section 111 determines YES and proceeds to ACT102.

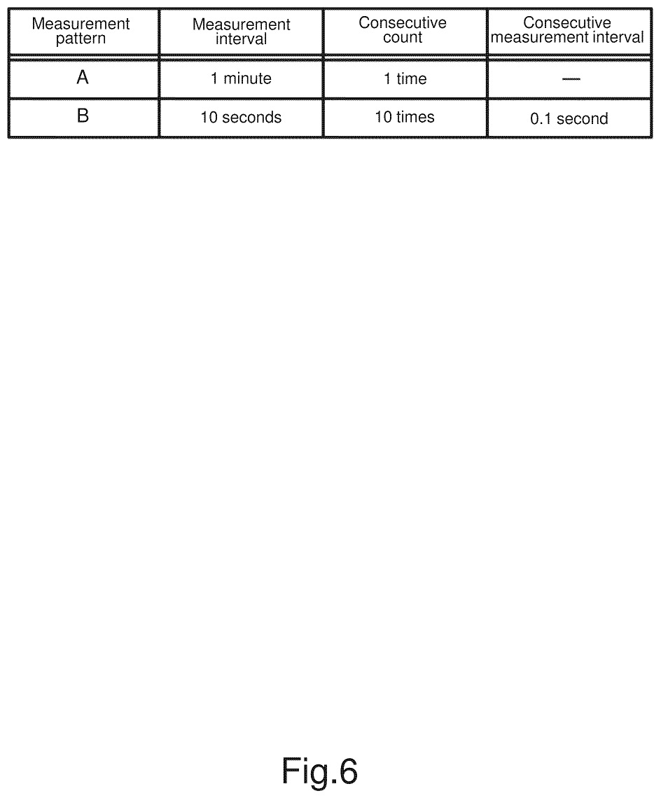

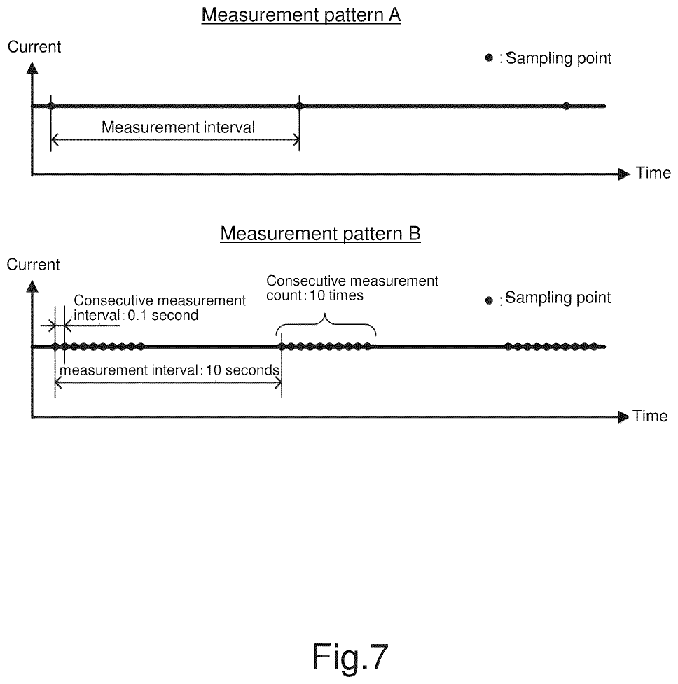

FIGS. 6 and 7 are diagrams showing examples of the measurement pattern. FIG. 6 shows measurement patterns in the form of a table, and FIG. 7 schematically shows each measurement pattern. In this embodiment, two types of a measurement pattern A and a measurement pattern B are included as measurement patterns. The measurement pattern A is used for determining whether the signal light 51 is operating or not, and the measurement pattern B is used for determining an actual operating state of the signal light 51.

Specifically, in the measurement pattern A, a measurement interval is “one minute”, and a consecutive count is “one time”. In other words, in the measurement pattern A, a current flowing through the signal light 51 is measured by the current sensor 6 detecting or sampling the current by one time at intervals of one minute.

In addition, in the measurement pattern B, the measurement interval is “10 seconds”, the consecutive count is “10 times”, and a consecutive measurement interval is “0.1 second”. In other words, in the measurement pattern B, a current flowing through the signal light 51 is measured at intervals of 10 seconds by the current sensor 6 detecting or sampling the current by 10 times at intervals of 0.1 second.

Therefore, the determination as to whether the measurement time of day has come in ACT101 is the determination as to whether “one minute” indicated by the measurement interval in the measurement pattern A has elapsed.

As ACT102, the signal light operating state determination processing section 111 performs a first current measurement. This first current measurement is a measurement based on the measurement pattern A. Specifically, the signal light operating state determination processing section 111 gives a measurement instruction to the current sensor 6 by one time, and receives a detection result of the current sensor 6.

As ACT103, the signal light operating state determination processing section 111 determines whether or not there is a current flowing through the signal light 51 on the basis of the received detection result of the current sensor 6. If there is no current flowing through the signal light 51, the signal light operating state determination processing section 111 determines NO and then proceeds to ACT104. In addition, if there is a current flowing through the signal light 51, the signal light operating state determination processing section 111 determines YES and then proceeds to ACT105.

As ACT104, the signal light operating state determination processing section 111 determines that the signal light operating state is “turned off”. The signal light operating state determination processing section 111 causes the temporary storage section 121 of the main memory 12 to store the determined signal light operating state. The signal light operating state determination processing section 111 then proceeds to ACT101.

By repeating the loop of ACT101 through ACT104 in such a manner, the signal light operating state determination processing section 111 waits until the signal light 51 enters an operating state other than “turned off” at intervals of one minute on the basis of the measurement pattern A.

As ACT105, the signal light operating state determination processing section 111 performs a second current measurement. This second current measurement is a measurement based on the measurement pattern B. Specifically, the signal light operating state determination processing section 111 gives a measurement instruction to the current sensor 6 by 10 times at intervals of 0.1 second, and receives a detection result of the current sensor 6. This is performed by a specified number of times at intervals of 10 seconds.

As ACT106, the signal light operating state determination processing section 111 determines whether or not the received detection result of the current sensor corresponds to the signal light pattern A according to the signal light pattern registered in advance included in the control program stored in the control program storage section 131. If the detection result of the current sensor 6 corresponds to the signal light pattern A, the signal light operating state determination processing section 111 determines YES and proceeds to ACT107. In addition, if the detection result of the current sensor 6 does not correspond to the signal light pattern A, the signal light operating state determination processing section 111 determines NO and proceeds to ACT108.

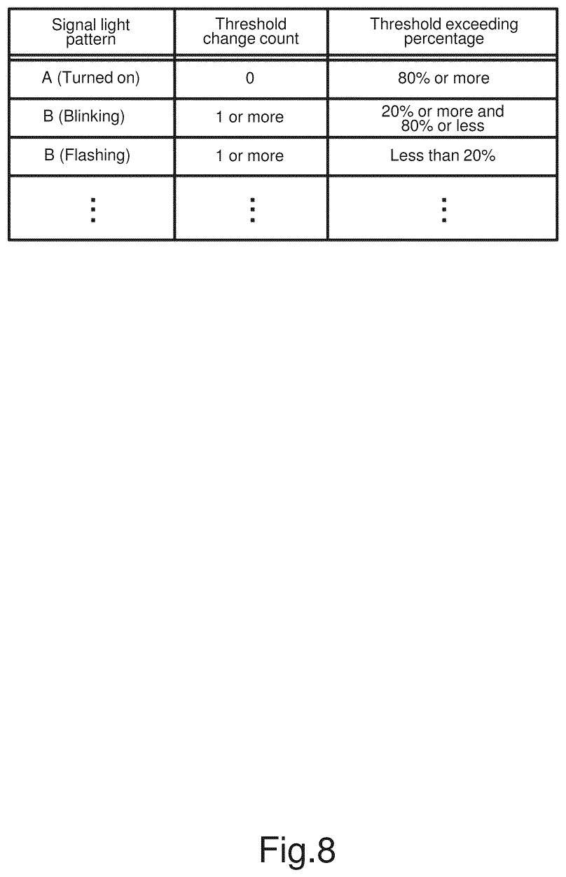

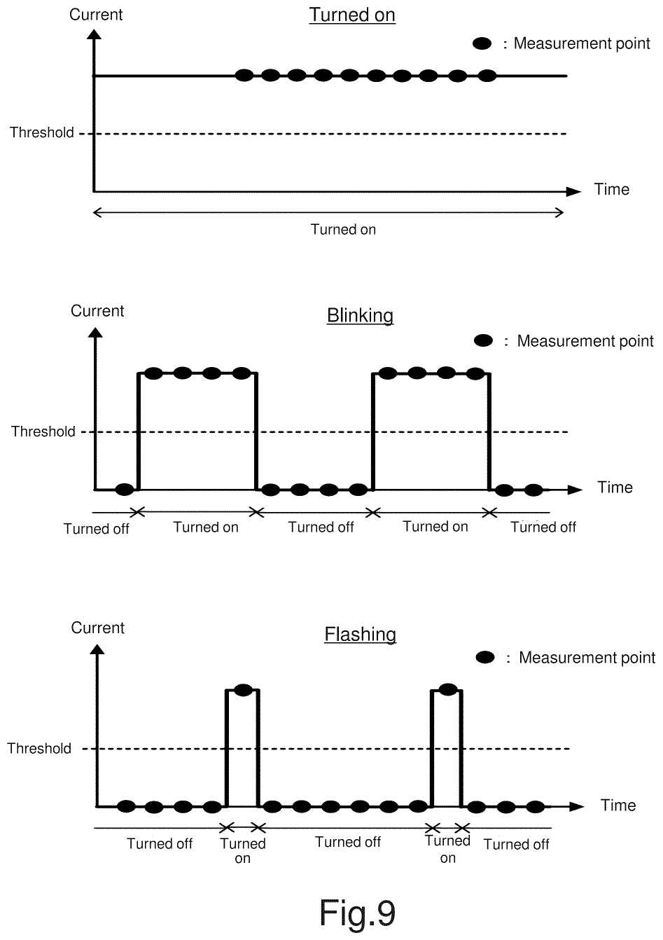

FIGS. 8 and 9 are diagrams showing examples of the signal light pattern. FIG. 8 shows signal light patterns in the form of a table, and FIG. 9 schematically shows each signal light pattern. In this embodiment, at least three types of a signal light pattern A, a signal light pattern B, and a signal light pattern C are included as signal light patterns. Each signal light pattern is defined by a “threshold change count” and a “threshold exceeding percentage”. The “threshold change count” is the number of times at which the current values at 10 respective measurement points that are the detection results of the current sensor 6 have changed relative to a threshold. The “threshold exceeding percentage” is the percentage of the current values at 10 respective measurement points exceeding the threshold.

For example, in the signal light pattern A, the “threshold change count” is “0”, and the “threshold exceeding percentage” is “80% or more”. The detection result of the current sensor 6 has such a value in the case where a current is continuously flowing through the signal light 51. Therefore, the case where the detection result of the current sensor 6 corresponds to the signal light pattern A is the time when the signal light 51 is in the operating state of “turned on”.

In addition, in the signal light pattern B, the “threshold change count” is “1 or more”, and the “threshold exceeding percentage” is “20% or more and 80% or less (or less than 80%)”. The detection result of the current sensor 6 has such a value in the case where a certain period in which the current flows through the signal light 51 and a certain period in which the current does not flow through the signal light 51 are alternately present. Those certain periods may differ from each other. Either certain period includes measurement points corresponding to a plurality of times. Therefore, the case where the detection result of the current sensor 6 corresponds to the signal light pattern B is the time when the signal light 51 is in the operating state of “blinking”.

In addition, in the signal light pattern C, the “threshold change count” is “1 or more”, and the “threshold exceeding percentage” is “less than 20%”. The detection result of the current sensor 6 has such a value in the case where a short period in which the current flows through the signal light 51 and a certain period in which the current does not flow through the signal light 51 are alternately present. The short period is a period including a measurement point by one time in the 10 measurement points. Therefore, the case where the detection result of the current sensor 6 corresponds to the signal light pattern C is the time when the signal light 51 is in the operating state of “flashing”.

Therefore, as ACT107, the signal light operating state determination processing section 111 determines that the signal light operating state is “turned on”. The signal light operating state determination processing section 111 causes the temporary storage section 121 of the main memory 12 to store the determined signal light operating state. Subsequently, the signal light operating state determination processing section 111 proceeds to ACT113.

As ACT108, the signal light operating state determination processing section 111 determines whether or not the received detection result of the current sensor 6 corresponds to the signal light pattern B in accordance with the signal light patterns described above. If the detection result of the current sensor 6 corresponds to the signal light pattern B, the signal light operating state determination processing section 111 determines YES and proceeds to ACT109. In addition, if the detection result of the current sensor 6 does not correspond to the signal light pattern B, the signal light operating state determination processing section 111 determines NO and proceeds to ACT110.

As ACT109, the signal light operating state determination processing section 111 determines that the signal light operating state is “blinking”. The signal light operating state determination processing section 111 causes the temporary storage section 121 of the main memory 12 to store the determined signal light operating state. Subsequently, the signal light operating state determination processing section 111 proceeds to ACT113.

As ACT110, the signal light operating state determination processing section 111 determines whether or not the received detection result of the current sensor 6 corresponds to the signal light pattern C in accordance with the signal light patterns described above. If the detection result of the current sensor 6 corresponds to the signal light pattern c, the signal light operating state determination processing section 111 determines YES and proceeds to ACT111. In addition, if the detection result of the current sensor 6 does not correspond to the signal light pattern C, the signal light operating state determination processing section 111 determines NO and proceeds to ACT112.

As ACT111, the signal light operating state determination processing section 111 determines that the signal light operating state is “flashing”. The signal light operating state determination processing section 111 causes the temporary storage section 121 of the main memory 12 to store the determined signal light operating state. Subsequently, the signal light operating state determination processing section 111 proceeds to ACT113.

As ACT112, the signal light operating state determination processing section 111 determines that the signal light operating state is another signal light operating state not shown in FIGS. 8 and 9. The signal light operating state determination processing section 111 causes the temporary storage section 121 of the main memory 12 to store the determined signal light operating state. Subsequently, the signal light operating state determination processing section 111 proceeds to ACT113.

As ACT113, the machine operating state determination processing section 112 implemented by the processor 11 determines a machine-to-be-monitored operating state corresponding to the signal light operating state stored in the temporary storage section 121 of the main memory 12, on the basis of the relationship between the signal light operating state and the machine-to-be-monitored operating state, the relationship being stored in advance in the correspondence storage section 132.

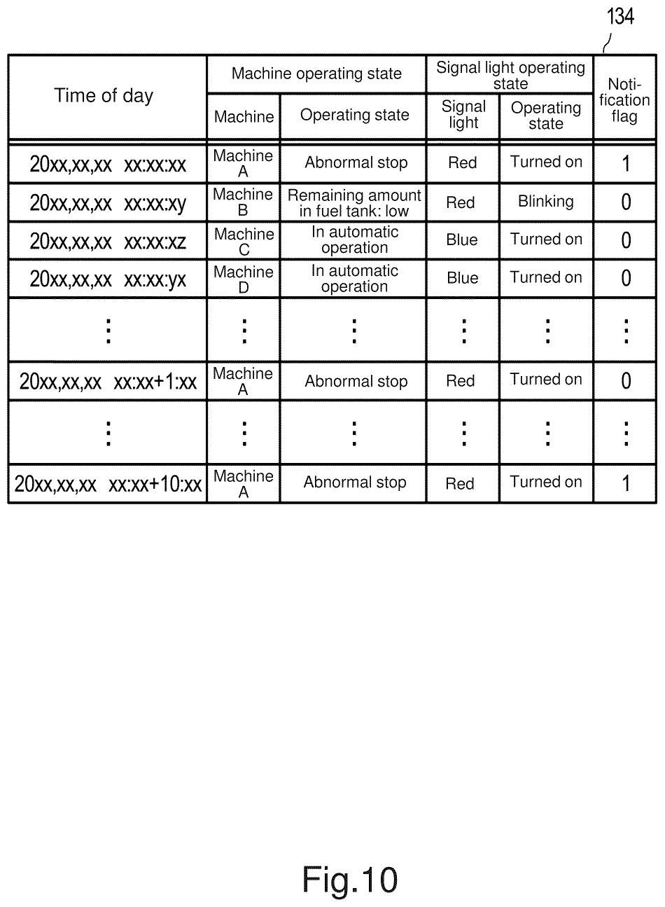

As ACT114, the machine operating state determination processing section 112 associates the determined machine-to-be-monitored operating state with the current time of day, which is measured by a clock (not shown), together with the signal light operating state, and additionally saves them in the operating state saving section 134. FIG. 10 is a diagram showing an example of saved contents of the operating state saving section 134. As shown in FIG. 10, the operating state saving section 134 saves, as one record, a “machine ID” and an “operating state” as the machine-to-be-monitored operating state, and a “signal light” and an “operating state” as the signal light operating state, in association with a time of day. The machine ID is unique identification information for identifying the machine to be monitored 2. Although not shown particularly in the figure, for example, if a correspondence between the current sensor 6 and the machine ID is stored in the auxiliary storage device 13, the machine operating state determination processing section 112 can confirm the correspondence and save the machine ID in the operating state saving section 134. Note that, as shown in FIG. 10, each record can further include a notification flag. This notification flag is a one-bit flag whose initial state is “0” (or “Null”). As will be described later, the notification flag is set to “1” when the notification processing section 113 implemented by the processor 11 performs notification to the notification destination terminal 3. In such a manner, the operating state saving section 134 is an example of a saving section that saves the operating state of the machine to be monitored 2, which has been determined by the second determination section, and the notification flag set when the notification processing section 113 notifies the operating state.

As ACT115, the notification processing section 113 implemented by the processor 11 determines whether or not there is a notification setting for the machine-to-be-monitored operating state in the record newly added and saved this time in the operating state saving section 134, that is, whether or not “Yes” is stored in the notification setting of the first notification for the corresponding machine-to-be-monitored operating state in the correspondence storage section 132. If there is no notification setting, the notification processing section 113 determines NO and proceeds to ACT105. In addition, if there is a notification setting, the notification processing section 113 determines YES and proceeds to ACT116.

As ACT116, the notification processing section 113 determines whether or not the signal light operating state has changed, that is, determines whether or not the signal light operating state thus determined of the machine to be monitored 2 is different from the signal light operating state of the machine to be monitored 2, which has been already stored in the operating state saving section 134. If there is no signal light operating state already stored or if the signal light operating state has changed, the notification processing section 113 determines YES and proceeds to ACT117. In addition, if the signal light operating state has not changed, the notification processing section 113 determines NO and proceeds to ACT119.

As ACT117, the notification processing section 113 performs first notification. For example, the notification processing section 113 reads, from the notification destination storage section 133, an actual notification destination address of the notification destination, which is indicated as a notification destination in the first notification stored in advance in the correspondence storage section 132 and corresponds to the machine-to-be-monitored operating state in the record newly added and saved this time in the operating state saving section 134. The notification processing section 113 then creates an e-mail to notify the machine-to-be-monitored operating state of the machine to be monitored 2 and transmits the created e-mail to the read notification destination address.

As ACT118, the notification processing section 113 sets “1” in the notification flag in the record newly added and saved this time in the operating state saving section 134. Subsequently, the notification processing section 113 proceeds to ACT105.

As ACT119, the notification processing section 113 determines whether or not there is a re-notification setting for the machine-to-be-monitored operating state in the record newly added and saved this time in the operating state saving section 134, that is, whether or not a re-notification setting time is stored in the re-notification setting of the second notification: for the corresponding machine-to-be-monitored operating state in the correspondence storage section 132. If there is no re-notification setting, the notification processing section 113 determines NO and proceeds to ACT105. In addition, if there is a re-notification setting, the notification processing section 113 determines YES and proceeds to ACT120.

As ACT120, the notification processing section 113 calculates the elapsed time since the signal light operating state has changed. Specifically, the notification processing section 113 calculates the difference between a time of day of the latest record in which “1” is set in the notification flag, among the records of the machine to be monitored 2 stored in the operating state saving section 134, and the current time of day measured with a clock not shown.

As ACT121, the notification processing section 113 determines whether or not a re-notification setting time has elapsed on the basis of the calculated elapsed time, the re-notification setting time being stored in the re-notification setting of the second notification of the correspondence storage section 132. If the re-notification setting time has not elapsed, the notification processing section 113 determines NO and proceeds to ACT105. In addition, if the re-notification setting time has elapsed, the notification processing section 113 determines YES and proceeds to ACT122.

As ACT122, the notification processing section 113 performs second notification. For example, the notification processing section 113 reads, from the notification destination storage section 133, an actual notification destination address of the notification destination, which is indicated as a notification destination in the second notification stored in advance in the correspondence storage section 132 and corresponds to the machine-to-be-monitored operating state in the record newly added and saved this time in the operating state saving section 134. The notification processing section 113 then creates an e-mail to notify the machine-to-be-monitored operating state of the machine to be monitored 2 and transmits the created e-mail to the read notification destination address. Subsequently, the notification processing section 113 proceeds to ACT118.

As described above, after the first notification is performed, the notification processing section 113 accumulates the records indicating the machine-to-be-monitored operating state of the machine to be monitored 2, as logs, in the operating state saving section 134 until the re-notification setting time elapses, while the notification flags in the records remain “0”. This allows the notification processing section 113 to easily calculate the elapsed time since the first notification. When the re-notification setting time has elapsed since the first notification, the notification processing section 113 performs second notification and sets “1” in the notification flag. Therefore, the elapsed time thereafter is calculated on the basis of a point in time at which the second notification has been performed instead of the first notification, and the second notification is performed repeatedly each time the re-notification setting time elapses.

As described above, according to this embodiment, the machine operating state monitoring system SYS includes the monitoring server 1 as an information processing apparatus, and the current sensor 6 that detects a current flowing through the signal light 51 that is attached to the machine to be monitored 2 and presents the operating state of the machine to be monitored 2. The signal light operating state determination processing section 111 of the monitoring server 1 causes the current sensor 6 to measure a current flowing through the signal light 51, and determines the operating state of the signal light 51 on the basis of the measurement result. The machine operating state determination processing section 112 of the monitoring server 1 determines the operating state of a machine to be monitored corresponding to the determined operating state of the signal light on the basis of the relationship between the operating state of the signal light 51 and the operating state of the machine to be monitored 2, the relationship being stored in advance in the correspondence storage section 132. In such a manner, the monitoring server 1 prepares, in the correspondence storage section 132, a database in which the operating state of the signal light 51 attached to the machine to be monitored 2 and the operating state of the machine to be monitored 2 corresponding thereto are associated with each other, determines the operating state of the signal light 51 by measuring a small current flowing through the signal light 51, and determines, on the basis of the determined operating state of the signal light 51, the operating state of the machine to be monitored 2 corresponding thereto, using the database. Therefore, according to this embodiment, it is possible to determine a detailed operating state of the machine by only measuring a current flowing through the signal light of the machine.

In addition, according to this embodiment, the signal light operating state determination processing section 111 of the monitoring server 1 causes the current sensor 6 to measure a current flowing through the signal light 51 in the measurement patterns set in advance, compares the measurement result with a signal light pattern corresponding to each operating state of the signal light 51 registered in advance, and determines an operating state corresponding to the signal light pattern with which the measurement result is matched, as the operating state of the signal light 51. Therefore, according to this embodiment, it is possible to determine the operating state of the signal light 51 by determining a pattern in which a current is flowing through the signal light 51.

Note that according to this embodiment the correspondence storage section 132 stores in advance a notification destination corresponding to the operating state of the machine to be monitored 2, and if a notification destination corresponding to the operating state of the machine to be monitored 2, which is determined by the machine operating state determination processing section 112, is stored in the correspondence storage section 132, the notification processing section 113 of the monitoring server 1 notifies the operating state of the machine to be monitored 2 to that notification destination. Therefore, according to this embodiment, it is possible to notify the operating state of the machine to be monitored 2 to the notification destination, which makes it possible to receive notification at the notification destination at a necessary timing without constantly monitoring the machine to be monitored 2, and take a suitable action for the machine to be monitored 2.

Here, according to this embodiment, the correspondence storage section 132 stores in advance the first notification destination and the second notification destination as the notification destinations. When the machine operating state determination processing section 112 determines the operating state of the machine to be monitored 2, the notification processing section 113 notifies the operating state of the machine to be monitored 2 to the first notification destination stored in the correspondence storage section 132. If the machine operating state determination processing section 112 continues to determine the operating state of the machine to be monitored 2 even after a re-notification period set in advance has elapsed since the notification to the first notification destination, the notification processing section 113 notifies the operating state of the machine to be monitored 2 to the second notification destination stored in the correspondence storage section 132. Therefore, according to this embodiment, it is possible to notify the operating state to the second notification destination when a suitable action is not taken in accordance with the first notification, which makes it possible to improve the certainty to take a suitable action for the machine to be monitored 2.

In addition, according to this embodiment, the monitoring server 1 includes the operating state saving section 134 that saves an operating state of a machine to be monitored, which has been determined by the machine operating state determination processing 112, a section and notification flag that is set when the notification processing section 113 notifies that operating state, and the notification processing section 113 determines whether or not a re-notification period has elapsed on the basis of the operating state and the notification flag that have been saved in the operating state saving section 134. Therefore, according to this embodiment, it is possible to easily determine a timing of a second notification by only confirming the notification flag.

In addition, according to this embodiment, the second measurement pattern is provided, which has a longer measurement interval or a smaller measurement count than the measurement pattern set in advance, and the signal light operating state determination processing section 111 of the monitoring server 1 causes the current sensor 6 to measure a current flowing through the signal light 51 in the second measurement pattern, switches the measurement pattern to the measurement pattern set in advance when a current is detected, and causes the current sensor 6 to measure a current flowing through the signal light 51. Therefore, according to this embodiment, it is possible to reduce the amount of communication between the current sensor 6 and the monitoring server 1, reduce the amount of data processing, and achieve power saving by changing the measurement pattern as necessary.

### Second Embodiment

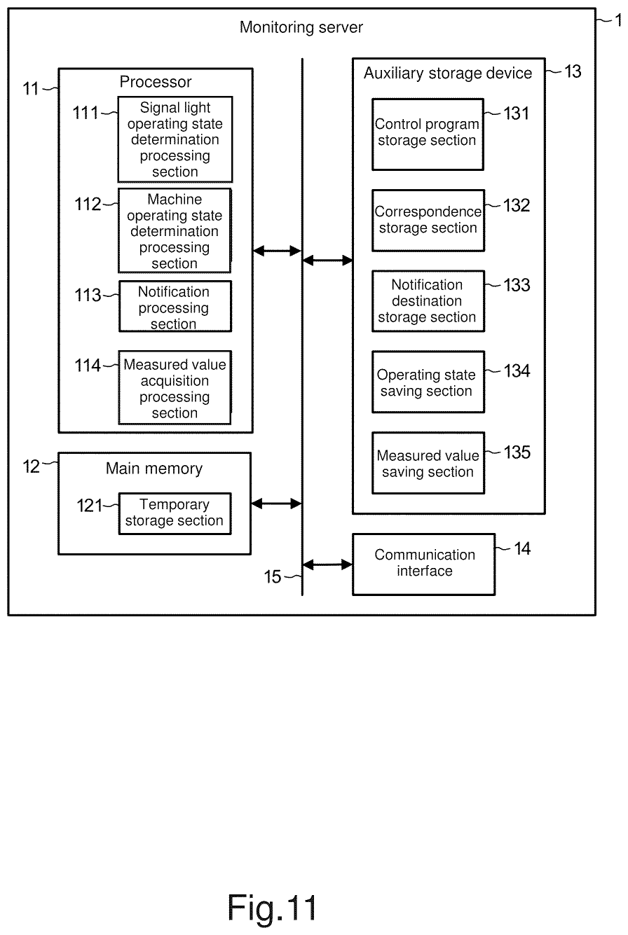

FIG. 11 is a block diagram showing a main part circuit configuration and a program outline of a monitoring server 1 as an information processing apparatus according to a second embodiment. In this embodiment, the monitoring server 1 includes a measured value saving section 135 in the auxiliary storage device 13, and implements a measured value acquisition processing section 114 in the processor 11.

In the first embodiment, the current sensor 6 detects a current flowing through a corresponding signal light 51 in accordance with a measurement instruction from the monitoring server 1. In contrast to that, in this embodiment, the current sensor 6 constantly detects a current, and notifies the detection result, as a measured value, to the monitoring server 1 via the communication network 4. The measured value acquisition processing section 114 receives the measured value from each current sensor 6 via the communication interface and saves the measured value in the measured value saving section 135. Therefore, in this embodiment, the current sensor 6 is an example of a measurement section that measures a current flowing through a signal light 51 that is attached to a machine to be monitored 2 and presents the operating state of the machine to be monitored 2.

The signal light operating state determination processing section 111 reads a necessary measured value from the measured values of the current sensors 6, which have been saved in the measured value saving section 135, in accordance with the measurement pattern A and the measurement pattern B as described in the first embodiment. Specifically, in the first current measurement of ACT102, the signal light operating state determination processing section 111 reads a measured value from the measured value saving section 135 at a timing matched with a sampling point in the measurement pattern A. In the second current measurement of ACT105, the signal light operating state determination processing section 111 reads a plurality of measured values from the measured value saving section 135 at timings matched with the respective measurement points in the measurement pattern B.

As described above, according to this embodiment, the machine operating state monitoring system SYS includes the monitoring server 1 as an information processing apparatus, and the current sensor 6 that measures a current flowing through the signal light 51 that is attached to the machine to be monitored 2 and presents the operating state of the machine to be monitored 2. The measured value acquisition processing section 114 of the monitoring server 1 receives a measured value measured by the current sensor 6 and saves it in the measured value saving section 135. The signal light operating state determination processing section 111 of the monitoring server 1 determines the operating state of the signal light 51 on the basis of the measured value of the current flowing through the signal light 51, which has been saved in the measured value saving section 135. The machine operating state determination processing section 112 of the monitoring server 1 then determines the operating state of a machine to be monitored corresponding to the determined operating state of the signal light on the basis of the relationship between the operating state of the signal light 51 and the operating state of the machine to be monitored 2, the relationship being stored in advance in the correspondence storage section 132. Therefore, also in this embodiment, it is possible to determine a detailed operating state of a machine by only measuring a current flowing through the signal light of the machine, as in the first embodiment.

In addition, according to this embodiment, it is unnecessary to give a measurement instruction from the monitoring server 1 to the current sensor, and thus the current sensor 6 also does not need a function of interpreting such a measurement instruction, which makes it possible to use a less expensive current sensor 6 that simply measures a current and perform communication and output. This can be expected to reduce costs significantly when the number of machines to be monitored 2 is large or when the number of signal lights 51 per machine is large.

The aforementioned embodiments can be implemented in various variations as follows.

For example, in the embodiments, the measurement patterns and the signal light patterns are provided as fixed information by a control program stored in the control program storage section 131, but those patterns may also be set discretionally and stored in advance in the auxiliary storage device 13.

In addition, in the embodiments, the case where the information processing apparatus is configured as a single monitoring server 1 has been described, but the information processing apparatus may be distributed to two or more apparatuses. For example, the signal light operating state determination processing section 111 and the machine operating state determination processing section 112 may be configured as separate apparatuses. In this case, the correspondence storage section 132 may be provided to each apparatus, or it may be provided to only one of the apparatuses and configured to allow access from the other apparatus or to receive and respond to inquiries from the other apparatus. Alternatively, the correspondence storage section 132 may also be configured as a data server connected to the communication network 4 and accessed from either apparatus. It is also possible to provide the function of the signal light operating state determination processing section 111 to an apparatus directly connected to a current sensor 6, and to transmit a signal light operating state from that apparatus to another apparatus including the machine operating state determination processing section 112 via the communication network 4. In such a manner, a destination for saving a database showing the relationship between the operating states, a processing section of measured data, and a destination for saving processed data may be configured in any combination in any component of the machine operating state monitoring system SYS.

In addition, in ACT116, the change in the signal light operating state is determined, but the change in the machine-to-be-monitored operating state already stored in the operating state saving section 134 may be determined.

In addition, the flow of the information processing performed by the processor 11 described above with reference to the flowcharts is an example, and it is not limited to the order thereof. For example, the order of ACT106 and ACT108 may be interchanged or performed in parallel. In such a manner, the order of processing may be changed or a plurality of processes may be performed in parallel as long as there is no conflict with the preceding or subsequent processes.

In addition, the notification is not limited to the two types of the first notification and the second notification, and the third and subsequent notification may also be performed.

In addition, in the embodiments, when the signal light operating state is determined from the measured current values, the signal light pattern is determined on the basis of the threshold exceeding percentage of the measured points, but the determination may be based on the number of measured points exceeding the threshold.

Additionally, the signal light operating state may be determined by detecting current values, such as the average value or effective value of the current over a certain period of time, by hardware circuitry rather than by software. For example, the signal light operating state can be determined as “turned on” if the detected current value is 10A, “blinking” if it is 5A, and “flashing” if it is 1A.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A machine operating state monitoring system, comprising:
a machine to be monitored;
a signal light attached to the machine to be monitored and configured to present an operating state of the machine to be monitored by changing an operating state of the signal light in accordance with the operating state of the machine to be monitored;
a current sensor connected to a network and configured to detect a current value of a current flowing through the signal light; and
a monitoring server configured to determine the operating state of the machine to be monitored, wherein
the monitoring server includes
a communication interface connected to the network,
a storage device configured to store in advance a relationship between the operating state of the signal light and the operating state of the machine to be monitored, and
a processor configured to
receive a detection result of the current value of the current flowing through the signal light from the current sensor via the communication interface,
determine the operating state of the signal light on a basis of the received detection result of the current value, and
determine the operating state of the machine to be monitored that corresponds to the determined operating state of the signal light on a basis of the relationship between the operating state of the signal light and the operating state of the machine to be monitored, the relationship being stored in the storage device.

2. The machine operating state monitoring system according to claim 1, wherein
the processor receives the detection result of the current value of the current flowing through the signal light in a measurement pattern set in advance from the current sensor via the communication interface.

3. The machine operating state monitoring system according to claim 2, wherein
the processor transmits a measurement instruction for detecting the current value of the current flowing through the signal light in the measurement pattern set in advance to the current sensor via the communication interface, and receives the detection result of the current value of the current flowing through the signal light from the current sensor via the communication interface.

4. The machine operating state monitoring system according to claim 1, wherein
the processor compares the received detection result of the current value with a signal light pattern that is set in advance and corresponds to the operating state of the signal light, and determines, as the operating state of the signal light, an operating state corresponding to the signal light pattern matched with the received detection result of the current value.

5. The machine operating state monitoring system according to claim 1, further comprising
a notification destination terminal connected to the network and operated to monitor the machine to be monitored, wherein
the storage device further stores in advance an address of the notification destination terminal, the address being a notification destination corresponding to the operating state of the machine to be monitored, and
the processor notifies, if the address that is the notification destination to the determined operating state of the machine to be monitored is stored in the storage device, the operating state of the machine to be monitored to the notification destination terminal having the address of the notification destination via the communication interface.

6. An information processing apparatus that monitors an operating state of a machine to be monitored, comprising:
a communication interface connected to a network, a current sensor being connected to the network, the current sensor being configured to detect a current value of a current flowing through a signal light attached to the machine to be monitored and configured to present the operating state of the machine to be monitored;
a storage device configured to store in advance a relationship between an operating state of the signal light and the operating state of the machine to be monitored; and
a processor configured to
receive a detection result of the current value of the current flowing through the signal light from the current sensor via the communication interface,
determine the operating state of the signal light on a basis of the received detection result of the current value, and
determine the operating state of the machine to be monitored that corresponds to the determined operating state of the signal light, on a basis of the relationship between the operating state of the signal light and the operating state of the machine to be monitored, the relationship being stored in the storage device.

7. The information processing apparatus according to claim 6, wherein
the processor receives the detection result of the current value of the current flowing through the signal light in a measurement pattern set in advance from the current sensor via the communication interface.

8. The information processing apparatus according to claim 7, wherein
the processor transmits a measurement instruction for detecting the current value of the current flowing through the signal light in the measurement pattern set in advance to the current sensor via the communication interface, and receives the detection result of the current value of the current flowing through the signal light from the current sensor via the communication interface.

9. The information processing apparatus according to claim 6, wherein
the processor compares the received detection result of the current value with a signal light pattern that is set in advance and corresponds to the operating state of the signal light, and determines, as the operating state of the signal light, an operating state corresponding to the signal light pattern matched with the received detection result of the current value.

10. An information processing method of monitoring an operating state of a machine to be monitored, the method comprising:
storing in advance a relationship between an operating state of a signal light and the operating state of the machine to be monitored, the signal light being attached to the machine to be monitored and configured to present the operating state of the machine to be monitored;
receiving a detection result of a current value of a current flowing through the signal light from a current sensor via a communication interface;
determining the operating state of the signal light on a basis of the received detection result of the current value; and
determining the operating state of the machine to be monitored that corresponds to the determined operating state of the signal light on a basis of the relationship between the operating state of the signal light and the operating state of the machine to be monitored, the relationship being stored in the storage device.
